(19) United States
(12) Patent Application Publication
(10) Pub. No.: US 2007/0274172 A1
(43) Pub. Date: Nov. 29, 2007

(54) Optical disc apparatus and data writing method therefor

(76) Inventors: Yukito Oda, Tokyo (JP); Shinichi Nakata, Tokyo (JP)

Correspondence Address: MCDERMOTT WILL & EMERY LLP, 600 13TH STREET, N.W., WASHINGTON, DC, 20005-3096, US

(21) Appl. No.: 11/702,197

(22) Filed: Feb. 5, 2007

(30) Foreign Application Priority Data
May 24, 2006 (JP) JP 2006-143751

(51) Int. Cl. G11B 7/00

(52) U.S. Cl. 369/44.27

(57) ABSTRACT

An optical disc apparatus comprises a control circuit for performing a first calibration process before the initiation of a write operation and performing a second calibration process during the write operation; the first calibration process includes the steps of: performing focus calibration for the objective lens at a plurality of radial positions on the optical disc based on the output of a photodetector; calculating the vertical disc deviation at the radial positions on the optical disc based on the results of the focus calibration; and based on information about the calculated vertical disc deviation, setting radial positions on the optical disc at which to perform focus calibration during the write operation; wherein the second calibration process includes the steps of: calculating the focus drive amounts, or focus movement ranges, at the set radial positions on the optical disc based on the results of the focus calibration in the first calibration process; and performing focus calibration at the set radial positions on the optical disc based on the calculated focus drive amounts, or focus movement ranges; and wherein during the write operation, focus control is performed based on the results of the second calibration process.

### CLAIM OF PRIORITY

The present application claims priority from Japanese application serial No. P2006-143751, filed on May 24, 2006, the content of which is hereby incorporated by reference into this application.

### BACKGROUND OF THE INVENTION

1. Technical Field of the Invention

The present invention relates to an optical disc apparatus, and more particularly to a focus control technique used to form a label image on an optical disc.

2. Description of the Related Art

Recently, a novel technique for forming an image on an optical disc by use of a disc drive has begun to be practically implemented. Specifically, this technique irradiates a thermosensitive material coated on a surface of an optical disc with a laser beam to thermally alter the color of the material and thereby form a grayscale image.

The prior art includes, for example, Japanese Laid-Open Patent Publication Nos. 2003-242669 and 2005-327425. The former publication discloses a technique that allows an optical disc read/write drive to accurately perform a focus control operation even on a low reflective area of an optical disc. Specifically, this focus control technique performs the following sequential steps: before performing a read or write operation on a low reflective area of an optical disc through laser beam irradiation, preliminarily performing a focus control operation on a high reflective area of the optical disc by irradiating the area with a laser beam; determining focus control parameters (or a focus control scheme) based on the results of the above preliminary focus control; storing the determined focus control parameters in memory; and when the low reflective area of the optical disc is irradiated with a laser beam for a read or write operation, performing a focus control operation using these focus control parameters. On the other hand, the latter publication (No. 2005-327425) discloses a technique that allows an optical disc apparatus to accurately perform a focus control operation even on an optical disc having a large vertical disc deviation when the disc drive reads from the optical disc. Specifically, this technique performs the following sequential steps: rotating the optical disc and moving the optical pickup up and down in a direction perpendicular to the surface of the optical disc with the same timing as the signals for detecting the rotation angle of the disc; at three or more locations on each track (or concentric circle) of the disc, detecting the focus drive value when the focal point of the optical beam coincides with the recording surface of the optical disc; calculating the vertical disc deviation at each location based on these detected focus drive values; and when a read operation is performed on a particular location on the optical disc, performing a focus control operation by the application of the focus drive (value) determined based on the vertical disc deviation at that location which was calculated based on its angular position on the disc.

### SUMMARY OF THE INVENTION

According to the above conventional techniques, an optical disc apparatus performs a focus calibration operation (that is, the above process of performing a preliminary focus control operation on an optical disc to determine an appropriate focus drive value for each location on the disc) only before the drive writes to an optical disc, not during the write operation. That is, when the optical disc apparatus writes to the optical disc, it controls focus based on the results of the focus calibration performed beforehand. Furthermore, these techniques use only a fixed number of fixed radial locations on the disc for focus calibration. This means that, for example, even an optical disc having a small vertical disc deviation is subjected to focus calibration at the same radial locations on the disc as an optical disc having a large vertical disc deviation. That is, the optical disc apparatus may perform unnecessary focus calibration operations and hence unnecessary focus control operations on the small vertical disc deviation disc, which may result in increased focus calibration time and hence increased write time. Furthermore, the increased number of focus calibration operations is likely to lead to degradation in the write quality.

The present invention has been devised to solve the foregoing problems with the prior art techniques, and thereby to allow an optical disc apparatus to efficiently perform focus calibration on an optical disc based on the vertical disc deviation conditions of the disc in order to achieve reduced write time and increased write quality.

A more specific object of the present invention is to provide an easy-to-use optical disc apparatus capable of forming a label image on an optical disc.

To achieve this object, the present invention provides the following techniques.

The present invention provides an optical disc apparatus for writing data to and/or reading data from an optical disc by irradiating the optical disc with a laser beam through an objective lens, the optical disc apparatus comprising: a photodetector; and a control circuit for performing a first calibration process before initiation of a write operation and further performing a second calibration process during the write operation; wherein the first calibration process includes the steps of: performing focus calibration at a plurality of radial positions on the optical disc based on the output of the photodetector in order to allow proper focus control of the objective lens; calculating the vertical disc deviation (including the warpage of the disc, or disc surface) at the radial positions (or focus calibration positions) on the optical disc based on the results of the focus calibration; and based on the calculated vertical disc deviation at the radial positions (or focus calibration positions) on the optical disc, setting radial positions (or focus calibration positions) on the optical disc at which to perform focus calibration during the write operation; wherein the second calibration process includes the steps of: calculating the focus drive amounts, or focus movement ranges, at the set radial positions on the optical disc based on the results of the focus calibration in the first calibration process; and performing focus calibration at the set radial positions on the optical disc based on the calculated focus drive amounts, or focus movement ranges; and wherein during the write operation, focus control is performed based on the results of the second calibration process.

### BRIEF DESCRIPTION OF THE DRAWINGS

FIG. 1 is a diagram showing an exemplary configuration of an optical disc apparatus according to an embodiment of the present invention.

FIG. 2 is a diagram showing the configuration of the write control system of the optical disc apparatus shown in FIG. 1.

FIG. 3 (including FIGS. 3A and 3B) is a diagram illustrating an exemplary radial position (or focus calibration position) setting operation in the first (or preliminary) calibration process performed by the optical disc apparatus shown in FIG. 1 before initiation of a write operation, wherein the optical disc apparatus sets radial positions on an optical disc at which to perform focus calibration during the write operation.

FIG. 4 is a diagram illustrating an exemplary calibration position re-setting operation in the second calibration process performed by the optical disc apparatus shown in FIG. 1 during a write operation, wherein the optical disc apparatus re-sets calibration positions subsequent to the current calibration position.

FIG. 5 is a diagram illustrating a photodetector employed in the optical disc apparatus shown in FIG. 1.

FIG. 6 is a flowchart illustrating the focus control operation performed by the optical disc apparatus shown in FIG. 1 when it writes to an optical disc.

### DETAILED DESCRIPTION OF THE PREFERRED EMBODIMENTS

A preferred embodiment of the present invention will be described with reference to the accompanying drawings.

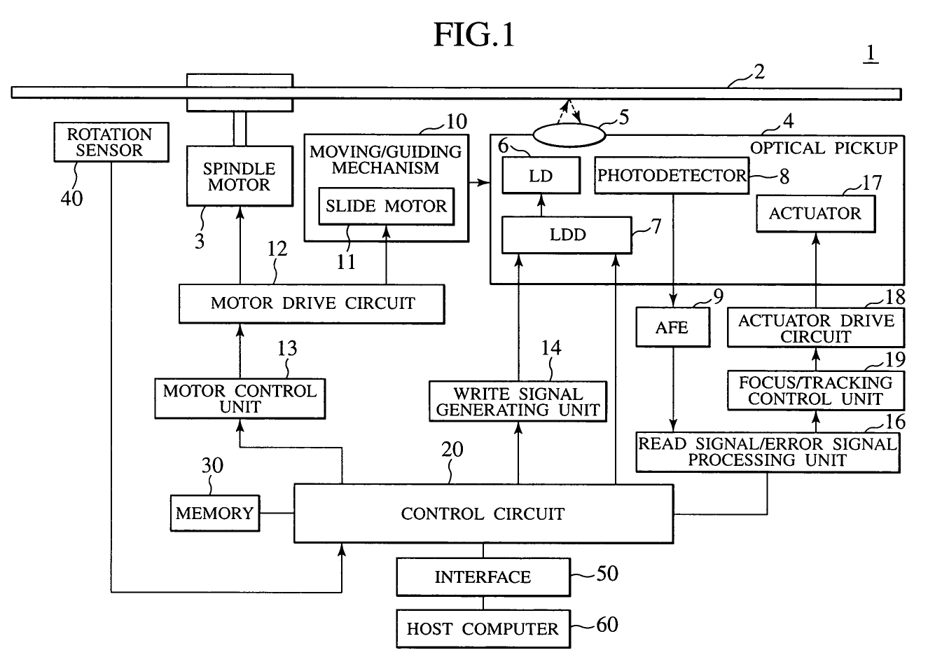

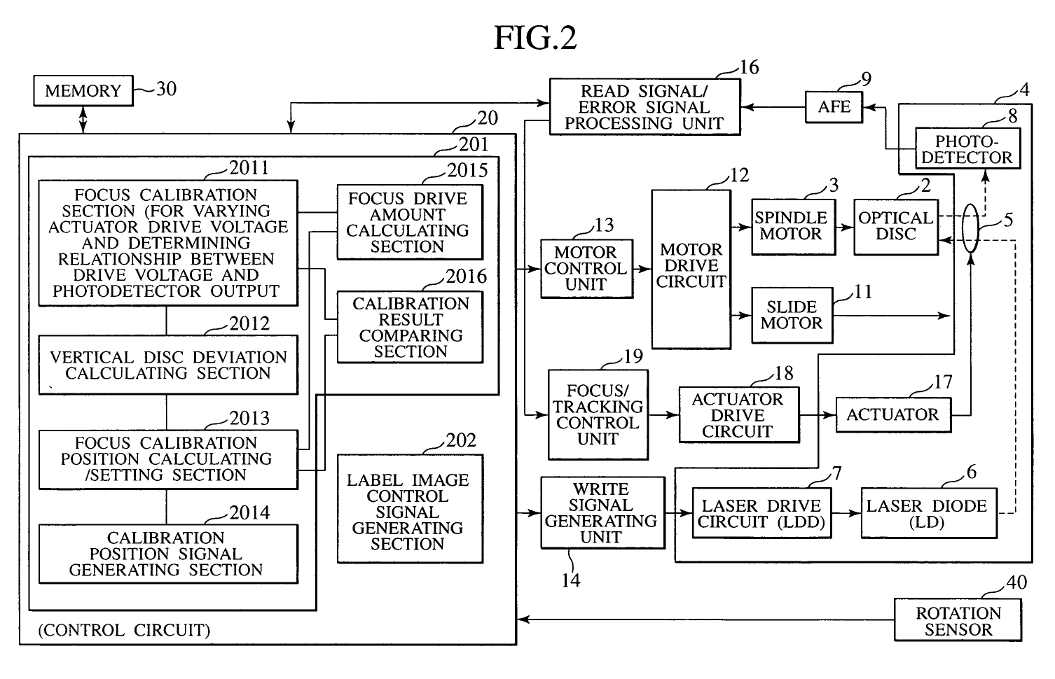

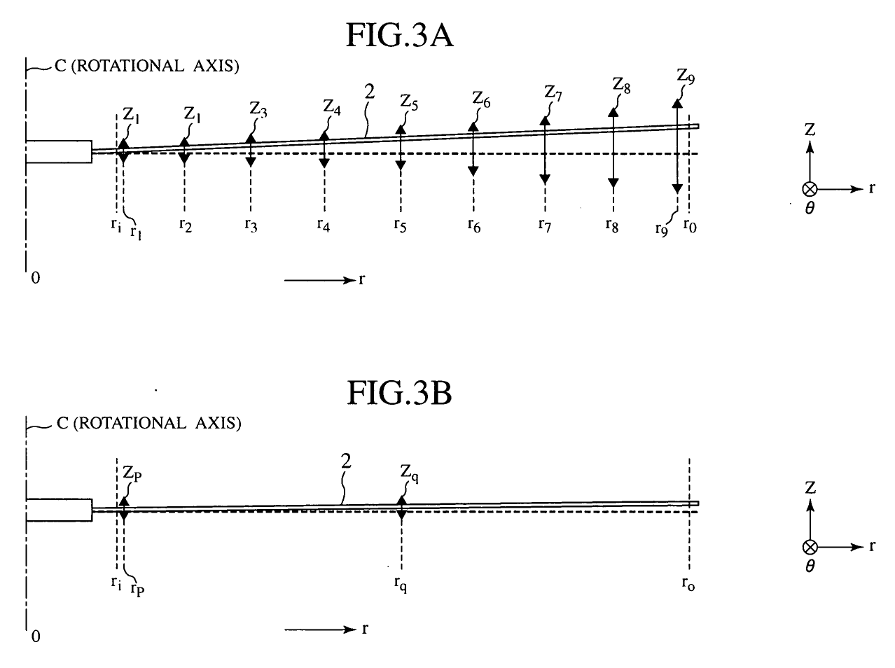

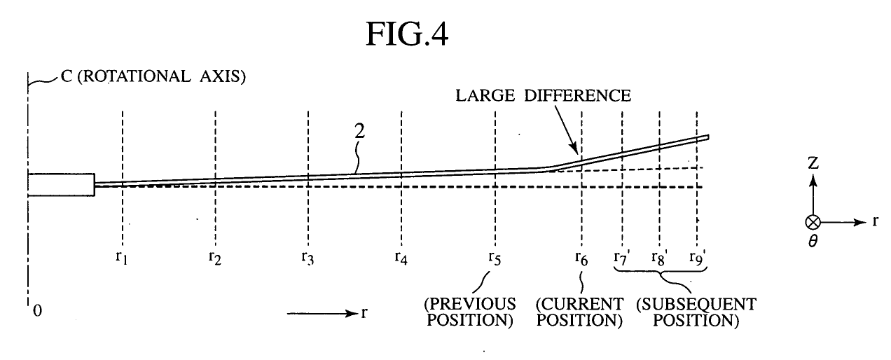

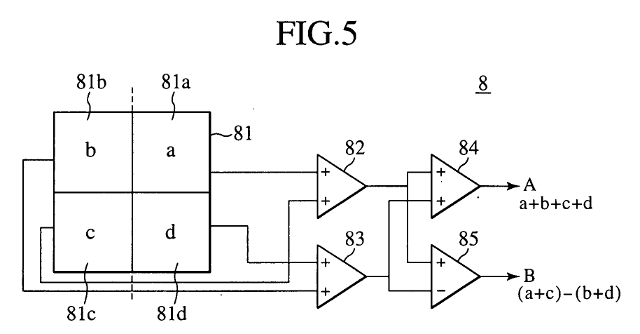

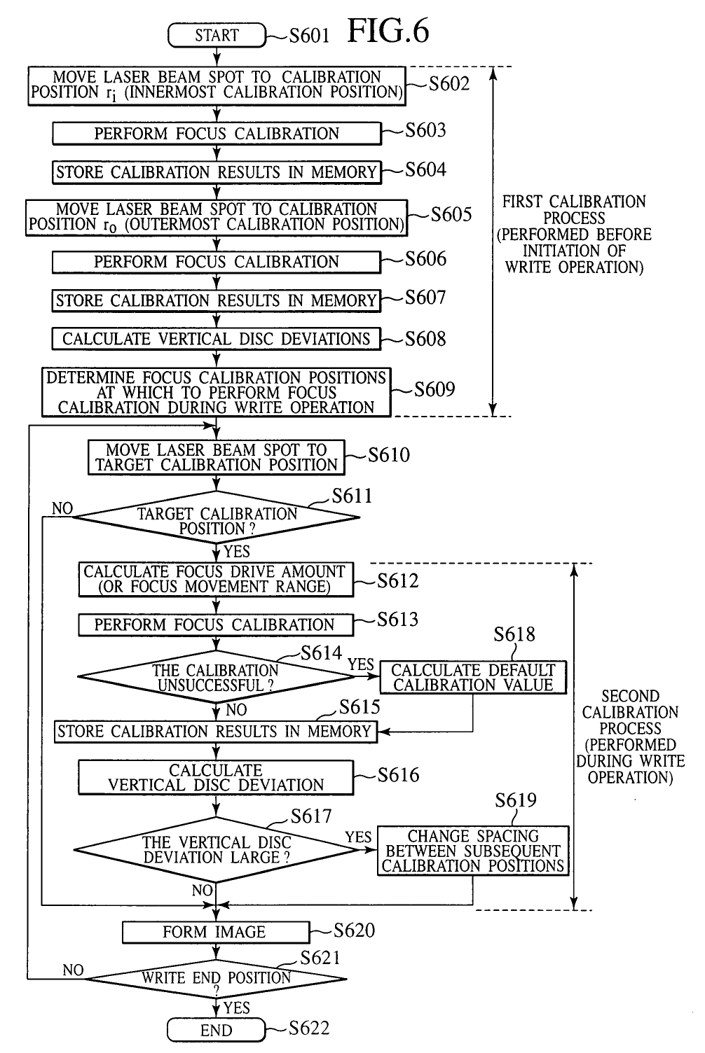

FIGS. 1 to 6 are diagrams illustrating the embodiment of the present invention. This embodiment provides an optical disc apparatus capable of forming a label image on a surface of an optical disc by irradiating the disc with a laser beam. Specifically, FIG. 1 is a diagram showing an exemplary configuration of the optical disc apparatus according to the embodiment of the present invention; FIG. 2 is a diagram showing the configuration of the write control system of the optical disc apparatus shown in FIG. 1; FIG. 3 is a diagram illustrating an exemplary radial position (or focus calibration position) setting operation in the first (or preliminary) calibration process performed by the optical disc apparatus shown in FIG. 1 before initiation of a write operation, wherein the optical disc apparatus sets radial positions on an optical disc at which to perform focus calibration during the write operation; FIG. 4 is a diagram illustrating an exemplary calibration position re-setting operation in the second calibration process performed by the optical disc apparatus shown in FIG. 1 during a write operation, wherein the optical disc apparatus re-sets calibration positions subsequent to the current calibration position; FIG. 5 is a diagram illustrating a photodetector employed in the optical disc apparatus shown in FIG. 1; and FIG. 6 is a flowchart illustrating the focus control operation performed by the optical disc apparatus shown in FIG. 1 when it writes to an optical disc.

Referring to FIG. 1, reference numeral 1 denotes the optical disc apparatus according to the embodiment of the present invention; 2, an optical disc; 3, a spindle motor for rotating the optical disc 2; 4, an optical pickup; 5, an objective lens; 6, a laser diode for emitting a laser beam having a predetermined intensity for read and write operations; 7, a laser drive circuit for driving the laser diode 6; 8, a photodetector for receiving the laser beam reflected from the recording surface of the optical disc 2 through the objective lens 5 and converting it into an electrical signal; 9, an analog front end for performing analog signal processing such as amplification of the signal received from the photodetector 8; 10, a moving/guiding mechanism made up of a straight guide member (not shown), a lead screw member (not shown), etc. and used to move the optical pickup 4 approximately in a radial direction of the optical disc 2; 11, a slide motor within the moving/guiding mechanism 10 for rotating the lead screw member (not shown); 12, a motor drive circuit for driving the spindle motor 3 and the slide motor 11; 13, a motor control unit for controlling the motor drive circuit 12; 14, a write signal generating unit for generating a write signal to write to the recording layer of the optical disc 2; 16, a read signal/error signal processing unit for processing the read signal from the photodetector 8 to obtain an RF signal, a tracking error signal, and a focus error signal; 17, an actuator within the optical pickup 4 for driving the objective lens 5 and thereby changing its position and attitude; 18, an actuator drive circuit for driving the actuator 17; 19, a focus/tracking control unit for generating and outputting a focus control signal and a tracking control signal; 20, a control circuit for controlling the motor control unit 13, the write signal generating unit 14, the laser drive circuit 7, the read signal/error signal processing unit 16, etc.; 40, a rotation sensor for detecting the rotational speed and rotational position (phase) of the optical disc 2; 50, an interface; and 60, a host computer.

The control circuit 20 is made up of, for example, a microprocessor or digital signal processor (DSP), etc. The host computer 60 transmits through the interface 50 to the control circuit 20 side the image data corresponding to a label image to be written, or formed, on the optical disc 2.

When the optical disc apparatus writes, or forms, a label image on the label forming surface of the optical disc 2, the control circuit 20 performs focus calibration before and after the initiation of the write operation in order to accurately control focus. Specifically, the control circuit 20 performs a first calibration process including preliminary focus calibration before the initiation of the write operation, and further performs a second calibration process including actual (or final) focus calibration after the initiation of the write operation. In the first calibration process (performed before the initiation of the write operation), the control circuit 20 controls each unit to perform the following sequential steps: for each of a plurality of radial positions on the optical disc 2, moving the objective lens 5 to the radial position and measuring the output of the photodetector 8 while varying the height position of the objective lens 5 relative to the label forming surface of the optical disc 2 by varying the drive voltage for the actuator 17 for driving the objective lens 5; based on the results of the measurement, determining the relationships between the height position, the drive voltage, and the photodetector output; and based on the determined relationships, determining the variation in the drive voltage and the level of the drive voltage at which the photodetector output is substantially maximized. (These steps are referred to collectively as “focus calibration.”) Then, the control circuit 20 further performs the steps of: calculating the vertical disc deviation of the optical disc (including the warpage of the disc, or disc surface) at each radial position based on the results of the above focus calibration; and calculating and setting radial positions on the disc at which to perform focus calibration during the write operation. In the second calibration process (performed after the initiation of the write operation), on the other hand, the control circuit 20 controls each unit to perform the following sequential steps: for each radial position on the optical disc set by the first calibration process, calculating the required focus drive amount (or focus movement range) at the radial position based on the results of the above focus calibration in the first calibration process, that is, based on the variations in the drive voltage for the actuator 17 in the first calibration process; and performing focus calibration at the radial position based on the calculated focus drive amount (or focus movement range). As in the focus calibration in the first calibration process, the latter step includes the following steps: measuring the output of the photodetector 8 while varying the height position of the objective lens 5 relative to the label forming surface of the optical disc 2 by varying the drive voltage for the actuator 17; based on the results of the measurement, determining the relationships between the height position, the drive voltage, and the photodetector output; and based on the determined relationships, determining the variation in the drive voltage and the level of the drive voltage at which the photodetector output is substantially maximized.

In the write operation, the control circuit 20 controls the focus of the objective lens 5 based on the results of the above second calibration process by controlling the drive voltage of the actuator drive circuit 18 through the read signal/error signal processing unit 16 and the focus/tracking control unit 19 and thereby controlling the actuator 17. After the above focus control operation, the control circuit 20 generates a control signal based on image data received from the host computer 60 side and outputs it to the write signal generating unit 14. Then, the write signal generating unit 14 generates a write signal based on this control signal and inputs it to the laser drive circuit 7. Based on this write signal, the laser drive circuit 7 drives the laser diode 6 to emit a laser beam. The laser beam is delivered to the label forming surface of the optical disc 2 through the focus-controlled objective lens 5, thermally altering the color of the thermosensitive material on the label forming surface and thereby forming a grayscale image.

Further, the rotation sensor 40 detects a rotational speed signal (or rotational frequency signal) and a rotational phase signal of the optical disc 2 generated by frequency signal generating means formed around the center hole of the optical disc 2, and inputs them to the control circuit 20. The frequency signal generating means may be made up of, for example, pluralities of transparent and nontransparent sectors alternately formed along a circumference of the optical disc 2. When the optical disc apparatus writes to the optical disc 2, based on the rotational speed signal and the rotational phase signal detected by the rotation sensor 40 the control circuit 20 controls the motor drive circuit 12 through the motor control unit 13 to rotate the spindle motor 3. Rotating the spindle motor 3 in this way causes the optical disc 2 to rotate at a predetermined rotational speed and a predetermined rotational phase. Since the rotation of the optical disc 2 is thus controlled, predetermined portions of the label forming surface of the optical disc 2 are irradiated with the laser beam (which corresponds to the write signal). This alters the color of the thermosensitive material on these portions, thereby forming a grayscale label image on the label forming surface.

It should be noted that in the following description of the optical disc apparatus, components common to FIG. 1 are designated by the same reference numerals.

FIG. 2 is a diagram showing the configuration of the write control system of the optical disc apparatus shown in FIG. 1. It should be noted that components common to FIG. 1 are designated by the same reference numerals.

Referring to FIG. 2, reference numeral 201 denotes a calibration section within the control circuit 20 for performing the first and second calibration processes in order to properly control the focus of the objective lens 5; 2011, a focus calibration section within the calibration section 201 for performing focus calibration in the first and second calibration processes (performed before and after the initiation of a write operation, respectively); 2012, a vertical disc deviation calculating section for, based on the results of the focus calibration performed by the focus calibration section 2011, calculating the vertical disc deviation of the optical disc 2 at radial positions (or focus calibration positions) on the disc, wherein at these focus calibration positions, the optical disc 2 has been subjected to focus calibration in the first calibration process, or will be subjected to focus calibration in the second calibration process; 2013, a focus calibration position calculating/setting section for, in the first calibration process (performed before the initiation of the write operation), calculating and setting radial positions, or focus calibration positions, on the disc based on the vertical disc deviations (including the warpage of the disc, or disc surface) calculated by the vertical disc deviation calculating section 2012, wherein at these focus calibration positions, the optical disc 2 will be subjected to focus calibration during the write operation; 2014, a calibration position signal generating section for generating a calibration position signal corresponding to each focus calibration position set by the focus calibration position calculating/setting section 2013; 2015, a focus drive amount calculating section for, during the write operation and based on the results of the focus calibration operations performed by the focus calibration section 2011, calculating the focus drive amount at each radial position on the disc calculated and set by the focus calibration position calculating/setting section 2013; 2016, a calibration result comparing section for, during the write operation, comparing the result of focus calibration at the current radial position (or focus calibration position) on the disc with the result of focus calibration at the previous radial position (or focus calibration position) and, based on the result of the comparison, generating and outputting a control signal; and 202, a label image control signal generating section for generating a control signal for causing the write signal generating unit 14 to generate a write signal corresponding to the label image data received from the host computer 60 side. All other reference numerals denote the same components shown in FIG. 1.

In the first calibration process (performed before the initiation of a write operation), the focus calibration section 2011 controls each unit to perform the following sequential steps: for each of a plurality of radial positions, or focus calibration positions, on the optical disc 2 (for example, the radial position of an innermost unwritten area of the optical disc 2, referred to as the “write start position,” and the radial position of an outermost unwritten area of the optical disc 2, referred to as the “write end position”), moving the objective lends 5 to the radial position and measuring the output of the photodetector 8 while varying the height position of the objective lens 5 relative to the label forming surface of the optical disc 2 by varying the drive voltage for the actuator 17; based on the results of the measurement, determining the relationships between the height position, the drive voltage, and the photodetector output; and based on the determined relationships, determining the variation in the drive voltage and the level of the drive voltage at which the photodetector output is substantially maximized. In the second calibration process (performed after the initiation of the write operation), on the other hand, the focus calibration section 2011 controls each unit to perform the following sequential steps: for each focus calibration position (or radial position) on the optical disc 2 set by the focus calibration position calculating/setting section 2013 during the first calibration process (performed before the initiation of the write operation), moving the objective lens 5 to the focus calibration position and measuring the output of the photodetector 8 while varying the height position of the objective lens 5 relative to the label forming surface of the optical disc 2 by varying the drive voltage for the actuator 17 based on the focus drive amount (or focus drive range) calculated by the focus drive amount calculating section 2015; based on the results of the measurement, determining the relationships between the height position, the drive voltage, and the photodetector output; and based on the determined relationships, determining the variation in the drive voltage and the level of the drive voltage at which the photodetector output is substantially maximized.

Based on the variations in the drive voltage for the actuator 17 determined in the first and second calibration processes performed before and after the initiation of the write operation, respectively, the vertical disc deviation calculating section 2012 calculates the vertical disc deviation of the optical disc 2 (including the warpage of the disc, or disc surface) at the focus calibration positions (or radial positions) on the disc set in the first and second calibration processes. Based on the vertical disc deviations calculated by the vertical disc deviation calculating section 2012, the focus calibration position calculating/setting section 2013 calculates and sets radial positions on the optical disc 2 at which to perform focus calibration during the write operation. The focus drive amount calculating section 2015 calculates the focus drive amount (or focus drive range) at each radial position (or focus calibration position) by interpolation based on the variations in the drive voltage for the actuator 17 determined in the first calibration process (performed before the initiation of the write operation). During the write operation (that is, after the initiation of the write operation), the calibration result comparing section 2016 compares the result of focus calibration at the current radial position (or focus calibration position) on the disc with the result of focus calibration at the previous radial position (or focus calibration position), and if the difference between the vertical disc deviations at these two positions exceeds a reference value, the calibration result comparing section 2016 sends a control signal to the focus calibration position calculating/setting section 2013 to set a smaller spacing between subsequent radial positions (or focus calibration positions) on the disc at which to perform focus calibration than set by the first calibration process.

Referring to the configuration shown in FIG. 2, based on the output (or calibration position signal) from the calibration position signal generating section 2014 in the calibration section 201 of the control circuit 20, the slide motor 11 is driven through the motor control unit 13 and the motor drive circuit 12, or the actuator 17 is driven through the focus/tracking control unit 19 and the actuator drive circuit 18, or both the slide motor 11 and the actuator 17 are driven. Further, the actuator 17 is also driven through the focus/tracking control unit 19 and the actuator drive circuit 18 based on the output from the focus drive amount calculating section 2015 in the calibration section 201. Further, the laser diode 6 is driven through the write signal generating unit 14 and the laser drive circuit 7 based on the output (or label image control signal) from the label image control signal generating section 202 in the control circuit 20.

It should be noted that in the following description of the optical disc apparatus, components common to FIG. 2 retain the same reference numerals.

FIG. 3 (including FIGS. 3A and 3B) is a diagram illustrating an exemplary focus calibration position (or radial position) calculating/setting operation performed by the focus calibration position calculating/setting section 2013 in the calibration section 201 of the control circuit 20 when the optical disc apparatus 1 shown in FIG. 1 performs the first calibration process before initiation of a write operation, wherein the focus calibration position calculating/setting section 2013 sets focus calibration positions (or radial positions) on the disc at which to perform focus calibration during the write operation. Specifically, FIG. 3A shows focus calibration positions set when the optical disc 2 has a relatively large amount of warpage or vertical disc deviation, while FIG. 3B shows focus calibration positions set when the optical disc 2 has a relatively small amount of warpage or vertical disc deviation.

Referring to FIG. 3, symbol c denotes the rotational axis of the optical disc 2; r, the radius (or disc radius) of the optical disc 2; rᵢ, the radial position of the innermost area (or the innermost radial position or the write start position) on the optical disc 2; and rₒ, the radial position of the outermost area (or the outermost radial position or the write end position) on the optical disc 2. It should be noted that FIG. 3 shows an example in which the optical disc apparatus 1 shown in FIG. 1 performs focus calibration at the two radial positions rᵢ and rₒ on the disc in the first calibration process (performed before the initiation of a write operation). In the first calibration process (performed before the initiation of a write operation), the focus calibration section 2011 controls each unit to perform the following sequential steps: when the laser beam spot created by the objective lens 5 has reached the radial positions rᵢ or rₒ on the disc, measuring the output of the photodetector 8 while varying the height position of the objective lens 5 relative to the label forming surface of the optical disc 2 by varying the drive voltage for the actuator 17; based on the results of the measurement, determining the relationships between the height position, the drive voltage, and the photodetector output; and based on the determined relationships, determining the variation in the drive voltage and the level of the drive voltage at which the output of the photodetector 8 is substantially maximized. The light receiving surface of the photodetector 8 is made up of a plurality of sectors; the output of the photodetector 8 is the result of adding the outputs of these sectors together.

The vertical disc deviation calculating section 2012 calculates the vertical disc deviation of the optical disc 2 (including the warpage of the disc, or disc surface) at the focus calibration positions (or radial positions) rᵢ and rₒ on the disc based on the variations in the drive voltage for the actuator 17 determined by the focus calibration section 2011. Then, based on the calculated vertical disc deviations at the focus calibration positions (or radial positions) rᵢ and rₒ on the disc, the focus calibration position calculating/setting section 2013 calculates and sets focus calibration positions (or radial positions) on the disc at which to perform focus calibration during the write operation. At that time, the focus calibration position calculating/setting section 2013 sets more focus calibration positions (and hence a smaller spacing therebetween) when the optical disc 2 has a relatively large amount of vertical disc deviation or warpage (as in FIG. 3A) than when the optical disc 2 has a small amount of vertical disc deviation or warpage (as in FIG. 3B). Increasing the number of focus calibration positions and hence reducing their spacing in this way allows enhancement of the write quality. In FIG. 3A, symbols r₁ to r₉ denote 9 focus calibration positions set by the focus calibration position calculating/setting section 2013. In FIG. 3B, on the other hand, there are 2 focus calibration positions (denoted by rₚ and r_{q}) set by the focus calibration position calculating/setting section 2013. Further, in FIG. 3A, symbols z1 to z9 denote the drive ranges (or focus drive amounts or focus movement ranges) of the objective lens 5 at the focus calibration positions r₁ to r₉, respectively. In FIG. 3B, on the other hand, symbols zₚ and z_{q} denote the drive ranges (or focus drive amounts or focus movement ranges) of the objective lens 5 at the focus calibration positions rₚ and r_{q}, respectively. It should be noted that the focus drive amount calculating section 2015 calculates these drive ranges (or focus movement ranges) for the objective lens 5 by interpolation after the initiation of the write operation based on the variation in the drive voltage for the actuator 17 determined based on the results of each focus calibration operation in the first calibration process.

It should be noted that in the following description of the optical disc apparatus, components common to FIG. 3 retain the same reference numerals.

FIG. 4 is a diagram illustrating an exemplary calibration position re-setting operation in the second calibration process performed by the optical disc apparatus 1 shown in FIG. 1 after the initiation of a write operation, wherein the optical disc apparatus re-sets calibration positions subsequent to the current calibration position. When, in the second calibration process, the control circuit 20 has detected that the difference between the vertical disc deviations (including the warpage of the disc, or disc surface) at the current and previous focus calibration positions exceeds a predetermined reference value (indicating that the vertical disc deviation of the optical disc increases with decreasing distance from its outer circumference, as shown in FIG. 4), the control circuit 20 sets a smaller spacing between subsequent focus calibration positions than set by the first calibration process.

Specifically, in the second calibration process, the calibration result comparing section 2016 in the calibration section 201 of the control circuit 20 compares the result of focus calibration at the current focus calibration position (or radial position) on the disc with the result of focus calibration at the previous focus calibration position (or disc radial position), and if the difference between the vertical disc deviations at these two positions exceeds a predetermined reference value, the calibration result comparing section 2016 sends a control signal to the focus calibration position calculating/setting section 2013 to set a smaller spacing between subsequent focus calibration positions than set by the first calibration process (performed before the initiation of the write operation). In FIG. 4, there is a large difference between the vertical disc deviations at the current focus calibration position r₆ and the previous focus calibration position r₅. (This difference exceeds a reference value.) In this case, based on the comparison result output from the calibration result comparing section 2016, the focus calibration position calculating/setting section 2013 sets additional subsequent focus calibration positions (denoted by r₇′, r₈′ and r₉′ in the figure) to reduce the spacing between subsequent focus calibration positions in order to prevent degradation of the write quality.

FIG. 5 is a diagram illustrating the photodetector 8 employed in the optical disc apparatus 1 shown in FIG. 1.

Referring to FIG. 5, reference numeral 81 denotes a light receiving surface made up of a plurality of sectors (4 sectors) 81a to 81d; a to d denote the outputs of the sectors 81a to 81d, respectively; 82 to 85 denote adders; A denotes the output of the adder 84; and B denotes the output of the adder 85. In the optical disc apparatus 1, when ordinary data (not a label image) is written to the optical disc 2, the above output B of the adder 85 is used to control the focus of the laser beam. On the other hand, when a label image is formed on a surface of the optical disc 2, the output A of the adder 84 is used to control the focus of the laser beam in the first and second calibration processes, which allows the photodetector 8 to provide an output level higher than a predetermined level even when the laser beam is reflected from a low reflective disc surface.

FIG. 6 is a flowchart illustrating the focus control operation performed in the optical disc apparatus 1 shown in FIG. 1 when it writes to an optical disc.

(1) The control circuit 20 starts its focus control operation at step S601.

(2) At step S602, the control circuit 20 drives the slide motor 11 and hence the moving/guiding mechanism 10 through the motor control unit 13 and the motor drive circuit 12 to move the optical pickup 4 and hence the objective lens 5 so as to move the laser beam spot to the innermost focus calibration position rᵢ on the optical disc 2.

(3) At step S603, the focus calibration section 2011 in the calibration section 201 of the control circuit 20 performs focus calibration at the above focus calibration position rᵢ based on the output from the photodetector 8. Specifically, the focus calibration section 2011 sends a control signal to the focus/tracking control unit 19 to perform the following substeps: measuring the output A (the full adder output shown in FIG. 5) of the photodetector 8 while varying the height position of the objective lens 5 relative to the label forming surface of the optical disc 2 by varying the drive voltage for the actuator 17; based on the results of the measurement, determining the relationships between the height position, the drive voltage, and the photodetector output A; and based on the determined relationships, determining the variation in the drive voltage and the level of the drive voltage at which the output A of the photodetector 8 is substantially maximized. (It should be noted that at the above substep of measuring the output A of the photodetector 8, the optical disc 2 is rotated 360 degrees and the measured values of the output A at different angular positions are averaged.)

(4) At step S604, the control circuit 20 stores the results of the focus calibration at step S603 into the memory 30.

(5) At step S605, the control circuit 20 drives the slide motor 11 through the motor control unit 13 and the motor drive circuit 12 to move the objective lens 5 so as to move the laser beam spot to the outermost focus calibration position rₒ on the optical disc 2.

(6) At step S606, the focus calibration section 2011 sends a control signal to the focus/tracking control unit 19 to perform the following substeps: after moving the laser beam spot to the outermost focus calibration position rₒ at step S605, measuring the output A (the full adder output shown in FIG. 5) of the photodetector 8 while varying the height position of the objective lens 5 relative to the label forming surface of the optical disc 2 by varying the drive voltage for the actuator 17; based on the results of the measurement, determining the relationships between the height position, the drive voltage, and the photodetector output A; and based on the determined relationships, determining the variation in the drive voltage and the level of the drive voltage at which the output A of the photodetector 8 is substantially maximized. (It should be noted that at the above substep of measuring the output A of the photodetector 8, the optical disc 2 is rotated 360 degrees and the measured values of the output A at different angular positions are averaged.)

(7) At step S607, the control circuit 20 stores the results of the focus calibration at step S606 into the memory 30.

(8) At step S608, the vertical disc deviation calculating section 2012 in the calibration section 201 of the control circuit 20 calculates the vertical disc deviations at the focus calibration positions (or radial positions) rᵢ and rₒ on the disc based on information on the variations in the drive voltage for the actuator 17 at these focus calibration positions. (This information was obtained at steps S603 and S606 and stored in the memory 3.)

(9) Based on the vertical disc deviations calculated by the vertical disc deviation calculating section 2012 at step S608, at step S609 the focus calibration position calculating/setting section 2013 in the calibration section 201 of the control circuit 20 calculates and sets focus calibration positions (or radial positions) on the disc at which to perform focus calibration during the write operation.

(10) At step S610, the control circuit 20 drives the slide motor 11 through the motor control unit 13 and the motor drive circuit 12 to move the objective lens 5 so as to move the laser beam spot to a focus calibration position set at step S609, for example, the focus calibration position r₁ shown in FIG. 3.

(11) After moving the objective lens 5 at step S610, the control circuit 20 determines at step S611 whether the laser beam spot is located at the predetermined focus calibration position, for example, the focus calibration position r₁.

(12) If it is determined at step S611 that the laser beam spot is located at the predetermined focus calibration position (for example, the focus calibration position r₁), at step S612 the focus drive amount calculating section 2015 in the calibration section 201 of the control circuit 20 calculates the focus drive amount (or focus movement range) at that focus calibration position based on the variations in the drive voltage for the actuator 17 determined through the focus calibration at steps S603 and S606.

(13) At step S613, the focus calibration section 2011 in the control circuit 20 performs focus calibration at the current focus calibration position, for example, the radial position r₁ on the disc, by moving the objective lens 5 (vertically) based on the focus drive amount (or over the focus movement range) determined at step S612. Specifically, the focus calibration section 2011 controls each unit to perform the following substeps: measuring the output of the photodetector 8 while varying the height position of the objective lens 5 relative to the label forming surface of the optical disc 2 based on the focus drive amount (determined by the focus drive amount calculating section 2015) by varying the drive voltage for the actuator 17; based on the results of the measurement, determining the relationships between the height position, the drive voltage, and the photodetector output; and based on the determined relationships, determining the variation in the drive voltage and the level of the drive voltage at which the output of the photodetector 8 is substantially maximized.

(14) At step S614, the control circuit 20 determines whether the focus calibration operation at step S613 has failed.

(15) If it is determined at step S614 that the focus calibration operation at step S613 is successful, the control circuit 20 stores the results of the focus calibration at step S613 into the memory 30 at step S615. On the other hand, if it is determined at step S614 that the focus calibration operation at step S613 has failed, or has not been properly carried out, due to external disturbance, etc., at step S618 the control circuit 20 calculates a default calibration value for the current focus calibration position (for example, the radial position r₁ on the disc) based on information about the variations in the level of the drive voltage for the actuator 17 at the focus calibration positions rᵢ and rₒ. (This information was obtained at steps S603 and S606 and stored in the memory 30.) The control circuit 20 then stores this default calibration value in the memory 30.

(16) At step S616, the vertical disc deviation calculating section 2012 in the calibration section 201 of the control circuit 20 calculates the vertical disc deviation at the current focus calibration position (for example, the radial position r₁ on the disc) based on information about the variation in the drive voltage for the actuator 17 (at that focus calibration position) stored in the memory 30.

(17) At step S617, the calibration result comparing section 2016 in the calibration section 201 of the control circuit 20 compares the result of the focus calibration at step S613 with the results of the focus calibration at steps S603 and S606 and determines whether the amount of the vertical disc deviation at the current focus calibration position (for example, the radial position r₁ on the disc) exceeds a predetermined reference value.

(18) If it is determined at step S617 that the amount of the vertical disc deviation at the current focus calibration position (for example, the radial position r₁ on the disc) is large and exceeds the predetermined reference value, at step S619 the calibration result comparing section 2016 sends a control signal to the focus calibration position calculating/setting section 2013 to set a smaller spacing between subsequent focus calibration positions (or radial positions) on the disc than set at step S609.

(19) If it is determined at step S617 that the amount of the vertical disc deviation at the current focus calibration position (for example, the radial position r₁ on the disc) is small and doesn't exceed a predetermined reference value, at step S620 the label image control signal generating section 202 in the control circuit 20 generates a label image control signal based on the label image data received from the host computer 60 side and outputs it to the write signal generating unit 14. Then, the write signal generating unit 14 generates a write signal based on this control signal and inputs it to the laser drive circuit 7. Based on this write signal, the laser drive circuit 7 drives the laser diode 6 to emit a laser beam. The laser beam is delivered to the label forming surface of the optical disc 2 through the focus-controlled objective lens 5, thermally altering the color of the thermosensitive material on the label forming surface of the optical disc 2 and thereby forming a grayscale image. It should be noted that even if it is determined at step S611 that the laser beam spot is not located at the predetermined focus calibration position, the label image control signal generating section 202 also generates a label image control signal by assuming that the laser beam spot is located at that focus calibration position and outputs it to the write signal generating unit 14, thereby allowing a label image to be formed on the label forming surface of the optical disc 2.

(20) At step S621, the control circuit 20 determines whether the laser beam spot has reached the write end position on the label image forming area of the label forming surface of the optical disc 2.

(21) If it is determined at step S621 that the laser beam spot has reached the write end position on the label image forming area of the label forming surface of the optical disc 2, the control circuit 20 does not perform any further write operation, completing formation of the label image at step S622. On the other hand, if it is determined at step S621 that the laser beam spot has not reached the write end position on the label image forming area of the label forming surface of the optical disc 2, the control circuit 20 returns to step S610 and moves the laser beam spot to the next write position (for example, the focus calibration position, or radial position, r₂) on the label forming surface of the optical disc 2. Then, at step S611, the control circuit 20 determines whether the laser beam spot is located at the next focus calibration position (for example, the radial position r₂) on the disc. After that, the control circuit 20 performs steps S612 to S621. Then, if it is determined at step S621 that the laser beam spot has not reached the write end position on the label image forming area of the label forming surface of the optical disc 2, the control circuit 20 returns to step S610 again and moves the laser beam spot to the next write position (for example, the focus calibration position, or radial position, r₃) on the label forming surface of the optical disc 2. Then, at step S611, the control circuit 20 determines whether the laser beam spot is located at the next focus calibration position (for example, the radial position r₃) on the disc. After that, the control circuit 20 performs steps S612 to S621. Then, if it is determined at step S621 that the laser beam spot has reached the write end position on the laser image forming area of the label forming surface of the optical disc 2, the control circuit 20 does not perform any further write operation, completing formation of the label image. Thus, the control circuit 20 repeats the above operations depending on the determination result at step S621.

It should be noted that the control circuit 20 automatically performs the above series of steps (S601 to S622) according to a program stored in memory means within the optical disc apparatus 1, such as the memory 30.

It should be further noted that the above steps S602 to S609 constitute the first calibration process described above, and the above steps S611 to S619 constitute the second calibration process described above.

Thus, the optical disc apparatus 1 of the present embodiment can reduce the number of focus calibration operations it performs, depending on the amount of warpage or the vertical disc deviation of the optical disc 2, resulting in reduced write time. Further, the optical disc apparatus 1 performs focus calibration at radial positions on the optical disc 2 determined based on the vertical disc deviation of the optical disc 2, which allows the optical disc apparatus to reliably achieve a certain level of write quality. Further, in the second calibration process (performed after the initiation of a write operation), when a focus calibration operation has failed, or has not been properly carried out, due to external vibration or foreign particles attached to the surface of the disc, the results of a focus calibration operation in the first calibration process may be retrieved from the memory 30 and used to avoid stopping the ongoing write operation, thereby preventing degradation of the write quality and reducing the write time. Further, the optical disc apparatus 1 of the present embodiment is easy to use, since it can quickly form a label image on a surface of an optical disc directly. Still further, the optical disc apparatus can have enhanced reliability for the reasons described above.

It should be noted that although in the above embodiment the memory 30 is provided separately from the control circuit 20, the present invention is not limited to this particular arrangement. The control circuit 20 may include the memory 30. Further, the above preferred embodiment has been described with reference to an example in which a label image is formed on the optical disc 2, the present invention can be applied to the writing of other data to the disc.

It will be apparent to those of ordinary skill in the art that the present invention may be embodied in other specific forms without departing from the spirit or essential characteristics thereof. The described embodiment is therefore to be considered in all respects as illustrative and not restrictive. The scope of the invention is indicated by the appended claims rather than the foregoing description, and all changes which come within the meaning and range of equivalents thereof are intended to be embraced therein.

What is claimed is:

1. An optical disc apparatus for writing data to and/or reading data from an optical disc by irradiating the optical disc with a laser beam through an objective lens, the optical disc apparatus comprising:
a photodetector for detecting the intensity of a laser beam reflected from a surface of the optical disc; and
a control circuit for performing a first calibration process before initiation of a write operation and further performing a second calibration process during the write operation;
wherein the first calibration process includes the steps of:
performing focus calibration at a plurality of radial positions on the optical disc based on the output of the photodetector in order to allow proper focus control of the objective lens;
calculating the vertical disc deviations at the radial positions on the optical disc based on the results of the focus calibration; and
setting radial positions on the optical disc at which to perform focus calibration during the write operation based on information about the calculated vertical disc deviations;
wherein the second calibration process includes the steps of:
calculating the focus drive amounts, or focus movement ranges, at the set radial positions on the optical disc based on the results of the focus calibration in the first calibration process; and
performing focus calibration at the set radial positions on the optical disc based on the calculated focus drive amounts, or focus movement ranges; and
wherein during the write operation, focus control is performed by driving the objective lens based on the results of the second calibration process.

2. The optical disc apparatus as claimed in claim 1, wherein in the first calibration process, the control circuit calculates the vertical disc deviation at an inner position and an outer position on the optical disc.

3. The optical disc apparatus as claimed in claim 1, wherein in the focus calibration in the first and second calibration processes, the control circuit performs the steps of:
measuring the output of the photodetector while varying the height position of the objective lens relative to the surface of the optical disc by varying the drive voltage for an actuator that drives the objective lens;
based on the results of the measurement, determining the relationships between the height position, the drive voltage, and the output of the photodetector; and
based on the determined relationships, determining the variation in the drive voltage and the level of the drive voltage at which the output is maximized.

4. The optical disc apparatus as claimed in claim 1, wherein in the first calibration process, the control circuit adjusts the number of radial positions on the optical disc at which to perform the focus calibration, and a spacing between the radial positions.

5. The optical disc apparatus as claimed in claim 4, wherein in the first calibration process, the control circuit sets a smaller spacing between the radial positions on the optical disc when the vertical disc deviation is large than when the vertical disc deviation is small.

6. The optical disc apparatus as claimed in claim 1, wherein in the second calibration process, when the vertical disc deviation is large and exceeds a predetermined reference value, the control circuit sets a smaller spacing between the radial positions on the optical disc at which to perform focus calibration than set in the first calibration process.

7. The optical disc apparatus as claimed in claim 1, wherein in the first calibration process, the control circuit determines the vertical disc deviation based on the maximum level of a full adder signal output from the photodetector.

8. The optical disc apparatus as claimed in claim 1, wherein in the second calibration process, if the focus calibration has failed, the control circuit determines a default calibration value based on the results of the focus calibration in the first calibration process and performs the write operation using the determined default calibration value.

9. A method for writing data to an optical disc using an optical disc apparatus that writes data to the optical disc by irradiating the optical disc with a laser beam through an objective lens, the method comprising:
a first step of detecting the intensity of a laser beam reflected from a surface of the optical disc;
a second step of performing focus calibration at a plurality of radial positions on the optical disc based on the results of the detection and calculating the vertical disc deviations at the radial positions on the optical disc based on the results of the focus calibration;
a third step of, based on the calculated vertical disc deviation, setting radial positions on the optical disc at which to perform focus calibration during a data write operation;
a fourth step of initiating the data write operation, and if the laser beam spot from the objective lens is located at one of the set radial positions on the optical disc, calculating the vertical disc deviation at the one radial position on the optical disc based on the vertical disc deviations obtained at the second step and determining the focus drive amount, or focus movement range, at the one radial position on the optical disc based on the results of the calculation;
a fifth step of performing focus calibration at the one radial position on the optical disc;
a sixth step of performing focus control based on the results of the focus calibration at the fifth step or based on the results of the focus calibration at the second step; and
a seventh step of, after the focus control, writing data to an area that follows the one radial position on the optical disc.

10. The method as claimed in claim 9, wherein the fifth step includes the steps of:
comparing the results of focus calibration at the current radial position on the optical disc with the results of focus calibration at the previous radial position on the optical disc; and
if the comparison indicates that the difference between the vertical disc deviation at the current and the vertical disc deviation at previous radial position is large and exceeds a reference value, setting a smaller spacing between (subsequent) radial positions on the optical disc at which to perform focus calibration than set at the third step.

11. The method as claimed in claim 9, wherein the sixth step includes the step of, if the focus calibration at the fifth step has failed, performing the focus control based on the results of the focus calibration at the second step.
